(19) United States
(12) Patent Application Publication
(10) Pub. No.: US 2014/0071439 A1
(43) Pub. Date: Mar. 13, 2014

(54) METHOD AND APPARATUS FOR MEASURING THE REFLECTION PROPERTIES OF A REFLECTOR

(71) Applicant: Andrea Pedretti-Rodi, Bellinzona (CH)

(72) Inventor: Andrea Pedretti-Rodi, Bellinzona (CH)

(73) Assignee: AIRLIGHT ENERGY IP SA, BIASCA (CH)

(21) Appl. No.: 13/981,281

(22) PCT Filed: Jan. 30, 2012
(86) PCT No.: PCT/CH12/00024

§ 371 Date: Nov. 25, 2013

(30) Foreign Application Priority Data
Jan. 28, 2011 (CH) 144/11

(51) Int. Cl. G01M 11/00

(52) U.S. Cl. CPC G01M 11/005
USPC 356/124

(57) ABSTRACT

The invention comprises a method and a device for measuring a reflector for radiation during the operation thereof, in which to determine the current reflection properties of the reflector in a number of at least one measurement points provided in the path of the radiation reflected by the reflector, the pattern of predetermined characteristics of the currently reflected radiation is measured and compared with a predetermined reference pattern, wherein the current geometrical properties of the reflector are inferred from the comparison and in the event of undesired geometrical properties, appropriate operational parameters of the reflector are modified. This method is preferably applied in trough collectors for solar power plants, in order to measure flexible concentrators arranged in a pressure cell, during their operation.

The present invention relates to a method for measuring the reflection properties of a reflector during its operation according to the preamble of claim 1, a reflector unit for implementing the method according to the preamble of claim 8, and a method for operating the reflector unit according to claim 14.

Reflectors of the above-mentioned type are known and are used for extremely diverse purposes, for example as antennas or solar collectors. Mostly, but not exclusively, these reflectors are used to focus and/or concentrate the received radiation, as is the case for parabolic antennas in radio astronomy or for solar concentrators in solar power technology. Large radio astronomy antennas have a solid structure and are correspondingly expensive, as is also the case for large solar concentrators that are used in industry in solar power plants. This also applies to smaller units however, which are often used as a group in order to jointly direct the focussed or concentrated radiation onto a receiver or absorber element.

In particular in the field of solar thermal power plants there are three basic shapes in use today: dish-sterling systems, solar tower power plant systems and parabolic trough systems.

Dish-Sterling systems are equipped with two-axis rotatably mounted paraboloid mirrors, with a diameter from a few meters to up to 10 m and more, allowing power levels of up to 50 kW per module to be obtained. The paraboloid mirrors can be divided into individual mirror segments so that the paraboloid shape is approximated as closely as possible at reasonable cost. Dish-Sterling systems have not generally established themselves.

Solar tower power plant systems have a central absorber, mounted in a raised position (on the “tower”), for the sunlight reflected onto it by hundreds to thousands of individual mirrors together, with which the radiation energy of the sun is concentrated over the many mirrors or concentrators in the absorber so that temperatures up to 1300° C. are to be obtained, which enhances the efficiency of the downstream thermal engines (usually a steam or liquid-driven turbine power plant for electricity generation). The “Solar two plant in California has an output capacity of several megawatts. The PS20 plant in Spain has a capacity of 20 megawatts. Solar tower power plants have up to now (in spite of the advantageously obtainable high temperatures) not been able to achieve a very broad distribution either.

Parabolic trough power plants are common however, and have collectors in large numbers that have long concentrators with a small transverse dimension, and thus do not possess a focal point but rather a focal line. These linear concentrators today have lengths of from 20 m to 150 m. Extending along the focal line is an absorber tube for the concentrated heat (up to around 500° C.), which transports the heat to the power plant. Possible transport media are e.g. thermal oil, molten salts or superheated water vapour.

The 9 SEGS parabolic trough power plants in Southern California together produce an output of approximately 350 megawatts. The “Nevada Solar One power plant connected to the grid in 2007 has trough collectors with 182,400 curved mirrors, arranged over a surface area of 140 hectares, and produces 65 MW output. Andasol 3 in Spain has been under construction since September 2009, is planned to commence operation in 2011, so that the Andasol plants 1 to 3 will have a maximum output power of 50 MW.

For the series production of collectors, in particular trough collectors, the applicant has proposed in WO 2010/037243 a system with a concentrator consisting of a flexible membrane pressurized in a pressure cell, which can be produced cost-effectively individually or serially, and approximates the parabolic shape of the ideal concentrator sufficiently exactly to achieve the temperatures of close to 500° C. or more required for an acceptable efficiency in the absorber tube. In principle, this system can also be used for paraboloid collectors and its use is conceivable in all forms of solar heat generation. It is also conceivable to use the design presented in WO 2010/037243 as reflectors for a very wide variety of purposes.

A disadvantage of this design is also one of its strongest advantages: the use of a pressurized, flexible membrane as a reflector or concentrator allows a highly cost-effective design with a perfectly smooth surface, since the membrane itself needs only to be exposed to a low pressure differential and can therefore be implemented as a thin foil without reinforcements (i.e. as a foil with a perfectly smooth surface), onto which a reflective layer is applied by vapour deposition. Despite spherical curvature of the foil, concentrations of 50 to 80 or even higher concentrations can be obtained, for example by means of sections with different radius of curvature, such as is shown in document WO 2010/037243 cited above.

However, because the reflector is implemented as a flexible membrane or foil, it has no rigidity itself and is also therefore susceptible to deviations from the intended shape, with the result that the efficiency of the collector then decreases unnecessarily. Such deviations can be caused by several factors, such as pressure variations across the concentrator or, for example, warpage in the frame in which the concentrator is mounted. In particular, in the event of a slow drift in the curvature of the concentrator, this deviation from the desired form can only be detected subsequently via the (unnecessary) loss of power of the collector, but in an early stage of the deformation possibly not at all, since the power of a collector can also be adversely affected by varying cloud levels, cooling by the wind, contamination etc.

Accordingly the object of the present invention is to provide a reflector unit in which the best possible efficiency in operation can constantly be obtained and maintained, within the limits of the design.

This object is achieved by a method for measuring a reflector according to claim 1, a reflector unit according to claim 8 and an operating method for the reflector unit according to claim 14.

Due to the fact that according to the invention the currently reflected radiation during operation is detected at measuring points and compared with a predetermined reference pattern, deviations of the currently reflected radiation from the reference pattern are detected as undesired deviations and corresponding operational parameters of the reflector are at least partially modified with zero delay in order to restore the target shape of the reflector.

Because the reflector unit according to the invention has a number of measurement points in the radiation path, the currently reflected radiation can be detected with a resolution corresponding to the number of measurement points and in real time or with zero delay a signal can be generated for the correction of operating parameters of the reflector unit.

Because after the setting of operating parameters on the reflector unit and the subsequent recording of the associated reference pattern individual reference patterns can be recorded for the respective reflector unit at the specific site, individually tuned reference patterns in the specific case (location of the reflector unit and its design) can be determined. Thus, for example, reference patterns for incident solar radiation angled according to the time of day and predetermined (but undesired) deformations of the reflector. Finally, even a non-optimal or erroneous alignment of the reflector relative to the radiation source can thus be detected in a reference pattern, and therefore the actual alignment of the reflector is continuously monitored and, if necessary, corrected.

The present invention allows not only the use of flexible reflectors or concentrators to be monitored, but also rigid reflectors, since these also can be subject to warpage. In the case of parabolic mirrors composed of segments, for example, the correct alignment of the individual rigid segments can be monitored.

In summary, the situation is such that by means of the present invention the reflection properties of any desired type of reflector, whether these be flexible or not, can be monitored continuously and therefore in real-time, in order to constantly maintain the best possible efficiency of the reflector within the limits of the design. This applies to small units as much as to large reflector units used on an industrial scale, where the maintenance of the best possible efficiency is a relevant cost factor.

Preferred embodiments are described by the dependent claims.

The invention is described in the following based on the figures using the example of solar collectors. As mentioned above, however, the invention can be used in reflectors for any type of radiation.

Shown are:

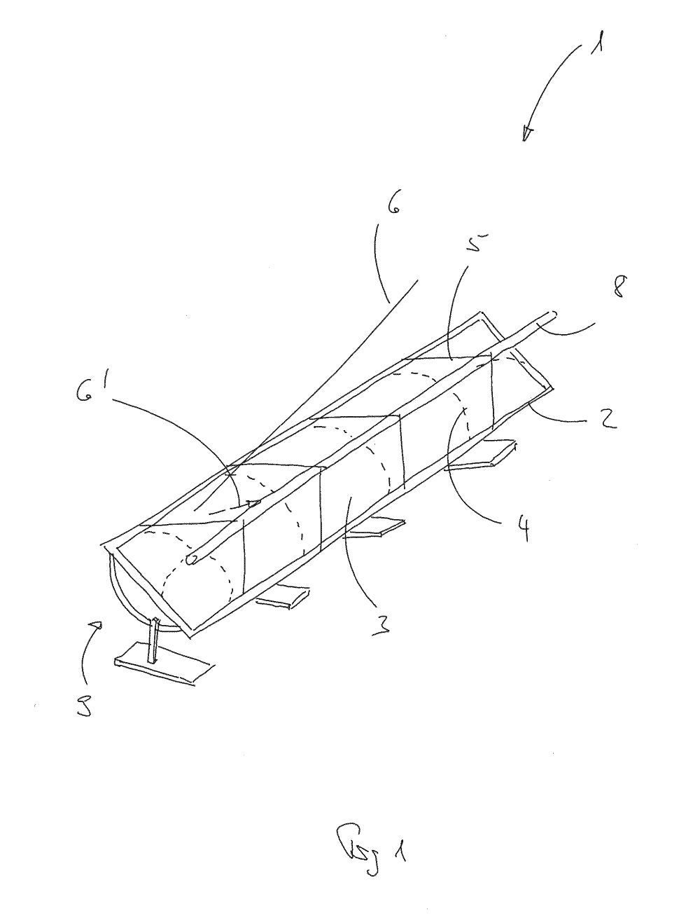

FIG. 1 a conventional trough collector with a pressure cell, in which a flexible concentrator is located

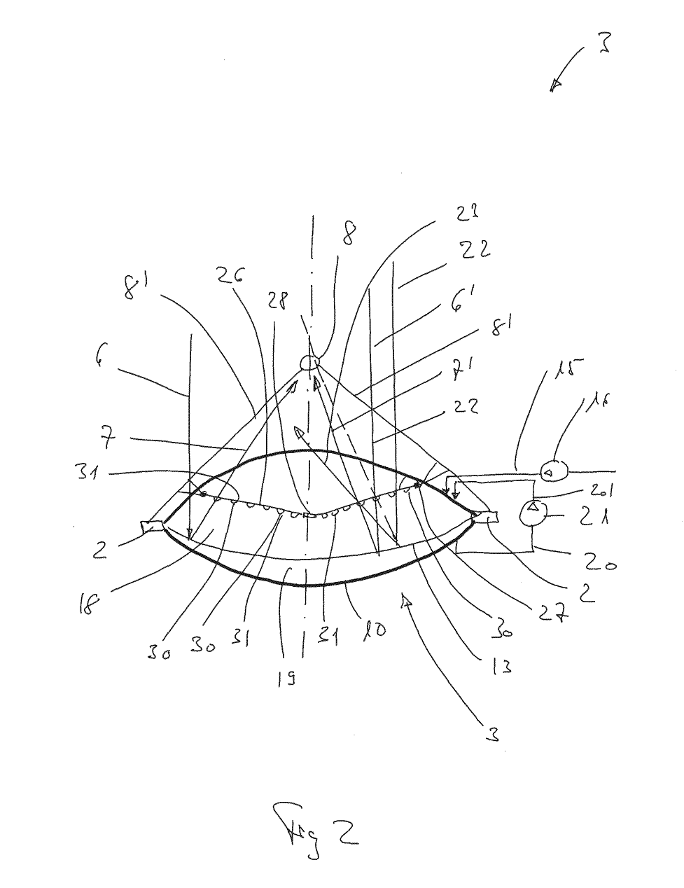

FIG. 2 a cross-section of the pressure cell of the trough collector of FIG. 1, equipped according to the present invention

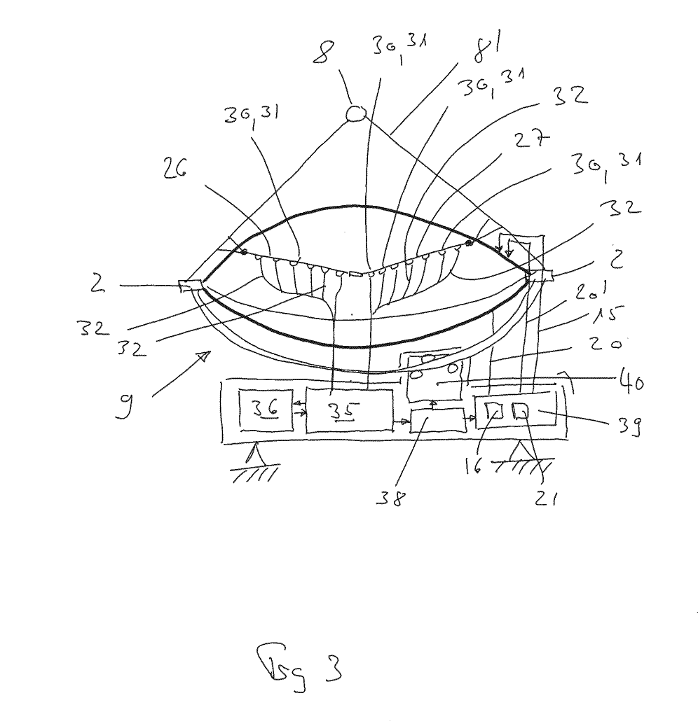

FIG. 3 a cross-section according to FIG. 2, additionally showing schematically the structure of the trough collector

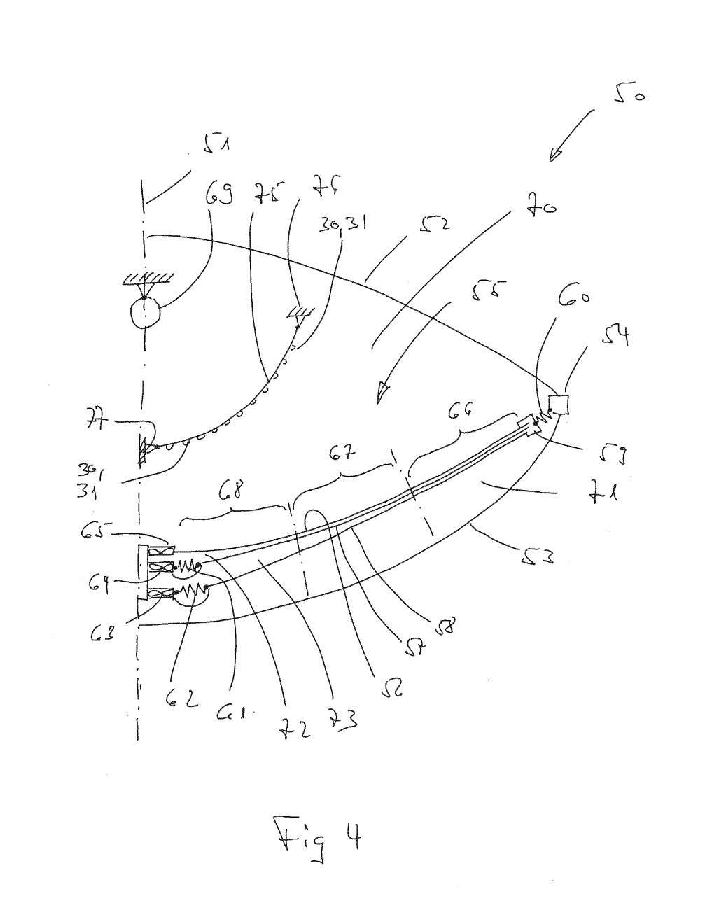

FIG. 4 a cross-section of the pressure cell of a further embodiment of a trough collector according to the invention

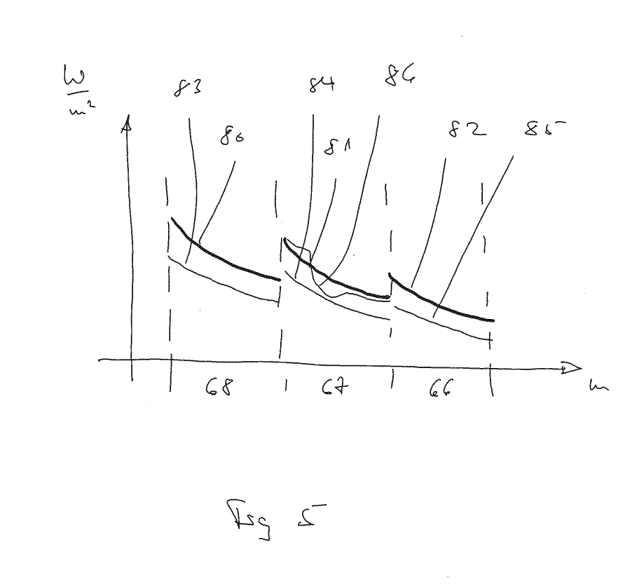

FIG. 5 examples of different current intensity patterns of the collector of FIG. 4 for target curvature of the concentrator and for an undesired deformation

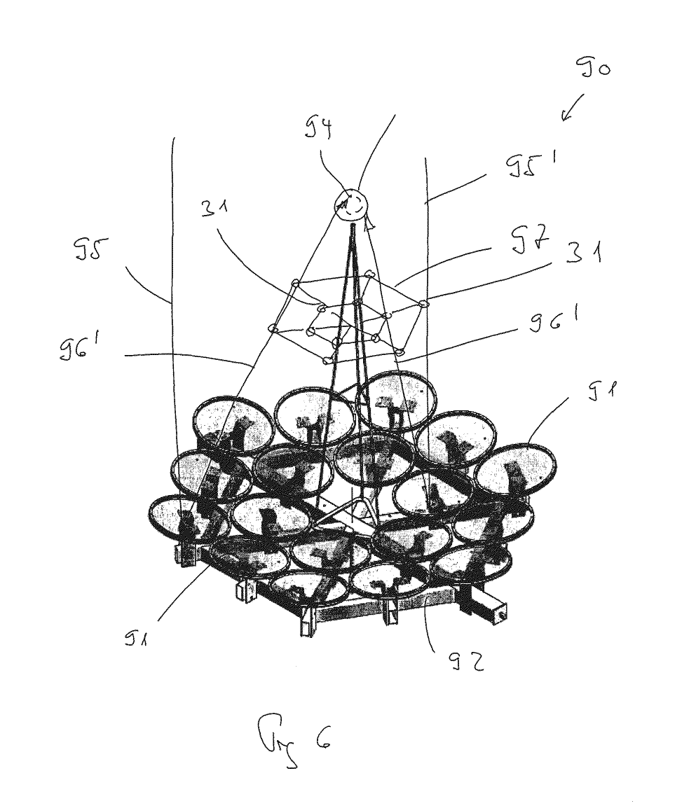

FIG. 6 a further embodiment of the present invention based on a parabolic collector

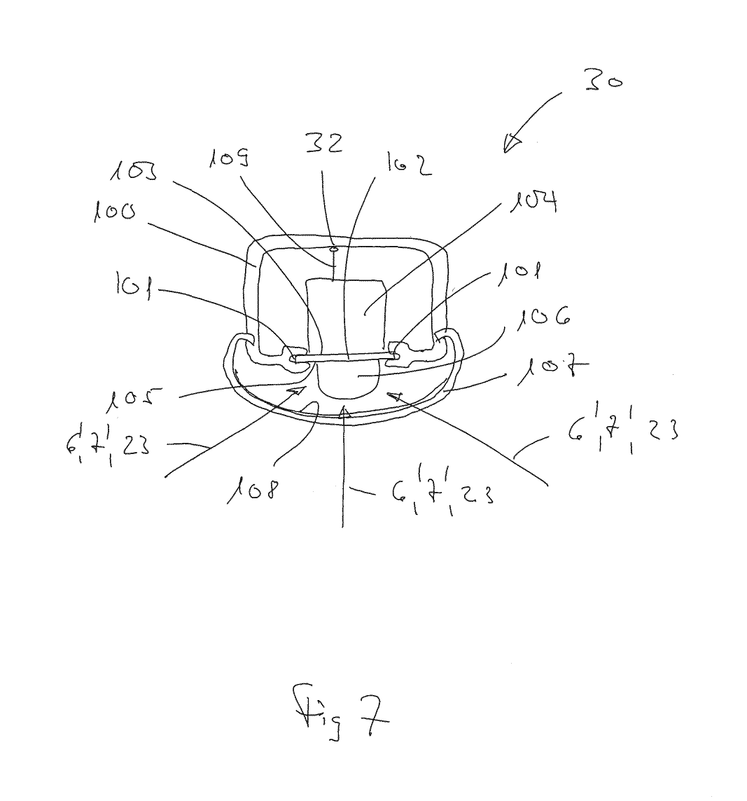

FIG. 7 a cross-section of a sensor for the reflected radiation in accordance with the present invention

FIG. 1 shows a trough collector 1 known to the person skilled in the art, such as can be used in their hundreds or thousands in a solar power plant on the industrial scale. In a frame 2 a pressure cell 3 is arranged, which due to the prevailing internal pressure in the operating condition has a pin-cushion shape indicated by the dotted lines 4. In the pressure cell 3, not visible in this case, a flexible concentrator 13 (FIG. 2) is arranged, which reflects the incident solar rays 6, as indicated by the reflected beam 6′. The reflected ray 6″ impinges on an absorber tube 8, mounted on supports 5, which dissipates the heat concentrated thereon by the reflected rays 6′ via a transport medium.

By means of a pivot device 9, the frame 2 with the pressure cell 3 can be rotated according to the position of the sun.

FIG. 2 shows a cross-section of the pressure cell 3 of the collector 1 of FIG. 1, wherein to avoid encumbering the figure the various components of the collector 1, such as the pivot device 9 (FIG. 1), are omitted or only schematically indicated.

Shown there are the frame 2 and the pressure cell 3, which is from a lower membrane 10 and an upper, transparent membrane 11. Located in the pressure cell 3 is the concentrator 13, onto which solar rays 6,6′ are incident and as reflected radiation 7,7′ heat up the absorber tube 8. The concentrator 13 preferably consists of a flexible, thin foil, the surface of which facing towards the solar rays 6,6′ is fitted with a vapour-deposited reflector layer and therefore has the required reflection properties. The path of the reflected radiation from the concentrator 13 is illustrated by the rays 7,7′ and 23 (see below).

Via a pressure line 15, fluid, in this case ambient air fed by a pump 16, is pumped into the pressure cell 3, which is thereby inflated to form a cushion with lenticular cross-section, as shown in FIG. 1. The pump 16 is preferably implemented as a fan, which maintains the desired pressure in the interior of the pressure cell 3, but which readily permits a change in the internal volume of the pressure cell 3, for example by exposure to wind.

The pressure cell 3 is divided by the concentrator 13 into an upper section 18 and a lower section 19, wherein the two areas 18,19 are connected to each other by a bypass 20, so that the lower section 19 is also supplied with pressurized ambient air via the upper section 18. A pump 21 (again, preferably a fan) between the two sections 18,19 maintains a pressure gradient, so that in the upper section 19 the pressure is p+Δp and in the lower section the pressure is p. Δp is relatively small, for example, 50 mbar. On the one hand, due to this small but sufficient pressure difference, the concentrator 13 is pressurized and so assumes the (spherical) curvature, which reflects the incident solar rays 6,6′ into a focal line region in which the absorber tube 8 is arranged. On the other hand, due to the small pressure difference the loading in the concentrator foil is small, so that a thin foil without reinforcements, i.e. with a smooth surface, can be used. Such a thin film has the good reflection properties required, but distorts easily from its desired shape when any faults occur, so that its curvature no longer corresponds to the desired curvature. This distortion may cover the whole concentrator surface, or only parts of it, down to just small sections in terms of area, but which in particular when added together to the thousands of collectors used in a solar power station, can certainly be relevant to its energy production. A deviation from the desired curvature can also be significant, however, even in small stand-alone collectors, for example with regard to the achievable peak temperature.

Such errors in the curvature of the concentrator 13 lead to an incident solar ray 22 being wrongly reflected and missing the absorber as a wrongly reflected ray 23.

Further shown schematically in the figure are two rails 26,27 connected together by a central section 28, which are suspended at the sides of the supports 8′ and which carry sensors 30, which are arranged at measurement points 31. The measurement points 31 are therefore located in the path of the reflected radiation, wherein the sensors 30 capture predetermined properties of the reflected radiation. Such rails can be arranged over the length of a collector 1 (FIG. 1), for example, spaced a distance of 10 m apart.

Measurement points 31 and sensors 30 can be spatially separated from each other and connected to each other for example by optical fibres, wherein the optical fibres then detect the reflected radiation at a measurement point 31 and guide it to a sensor 30 remote from this. This can be desirable in relation to the shadow cast by a sensor or in relation to the design of central sensors with a plurality of inputs, because in the case of a reflector or concentrator 13 with a large surface area, hundreds of measurement points 31 can be provided. In the present exemplary embodiment shown however, the sensors 30 are arranged at the location of the measurement points 31, or the measurement points 31 coincide with the sensors 30.

FIG. 3 shows the collector 1 of FIG. 1 with the pressure cell according to FIG. 2, wherein its structure is shown schematically. The sensors 30 that are provided at the location of the measuring points 31 are connected via signal lines 32 with an analysis unit 35 for the signals generated by the sensors 30. The analysis unit 35 is interconnected with a memory 36 for reference patterns and designed to compare the pattern of the signals received by the sensors 30 with at least one reference pattern stored in the memory 36 and to generate signals corresponding to the comparison, which in turn are fed into a control unit 38 for operational parameters of the collector 1. In the embodiment described here the control unit 38 accordingly activates the pumps 16, 21 (FIG. 2) of the pressure generation unit 39 or the drive 40 of the pivot unit 9, in order to constantly maintain the optimal alignment of the concentrator 13, or its curvature, during operation of the collector 1.

In summary, a reflector unit is shown which is implemented as a trough collector with a concentrator membrane clamped in a pressure cell which is pressurized during operation, wherein the controller for operational parameters is designed to modify parameters for the operating pressure applied to the concentrator membrane and/or the operating tension of a tensioning device for the concentrator membrane, such that the curvature thereof changes.

At this point, it should be emphasised that, depending on the design of a reflector unit (here of the collector 1), an extremely wide range of operational parameters influence the reflection properties of its reflector (here the concentrator 13). The compressive loading of the concentrator 13, or its alignment with respect to the position of the sun, are therefore only examples of such operational parameters. A further operational parameter is formed for example by the stress induced in the concentrator 13 via the frame 2, so that this assumes the desired spherical curvature under the operating pressure. Depending on the specific design of the reflector unit, the person skilled in the art will select the operating parameters which determine the best optimal reflection properties of the reflector, and which specify the corresponding design of the analysis unit and the controller of the reflector unit.

A first set of parameters preferably relates to the geometry of the curvature of the surface of the reflector and/or another set of parameters to the alignment of the reflector in relation to the radiation incident thereon.

FIG. 4 illustrates schematically a further embodiment of the present invention, wherein a cross-section through one half of a pressure cell 50 of a trough collector is shown. The other half, not shown, is symmetrical to the half that is shown with respect to the line of symmetry 51. To avoid encumbering the figure the other components, such as are shown in FIG. 3 by way of example, are omitted.

An upper, transparent membrane 52 and a lower membrane 53 form a pressure cell 50, positioned on the frame 54, which includes a concentrator arrangement 55. The concentrator arrangement 55 in the embodiment shown consists of three partially intersecting concentrator membranes 56 to 58, with the uppermost concentrator membrane 56 being coated with a reflecting layer. Along its outer edge the concentrator membranes 56 to 58 are fixed in place one on top of another by a longitudinal rail 59, which is in turn connected to the frame 54 via a clamping element 60. Along their inside the membranes 56 to 58 are arranged separately on a central strip 62, the membranes 58 and 59 also being attached here via tensioning elements 61 and 62. Three fans 63 to 65 represent the pressures required for operation in the spaces formed by the membranes 56 to 58. This arrangement is described in WO 2010/037243 and is known to the person skilled in the art. As a result of the membranes 56 to 58 resting on each other only in some sections, three sections 66 to 68 are obtained with different spherical curvature of the reflecting membrane 56, which improves the approximation of its curvature to a parabola and accordingly better concentrates the radiation against the absorber tube 69, with the result that a higher concentration is obtained.

In this case, four pressure chambers, namely the upper section 70 of the pressure cell 50, the lower section 71 of the pressure cell and the first and the second pressure chamber 72,73 between the concentrator membranes 56 to 58 and three tensioning elements 60 to 62 are provided, or four operating parameters relating to pressure and three operating parameters relating to stress, wherein a deviation in any of these operating parameters leads to a reduction of the achievable concentration of the collector. As mentioned above, other operating parameters are also available depending on the specific design, or, in the case of a simple or stand-alone design, only a single one. For all operating parameters, however, it is true that the person skilled in the art who has designed the specific collector knows its effect on the functioning of the collector, and thus in the event of an undesired deviation of the concentration, can define the displayed correction of the respective operational parameters.

Measurement points 31 are located on a rail 75 arranged in the pressure cell 50, the suspensions 76,72 of which in the pressure cell 50 are only shown schematically as fastenings. At least one measurement point 31, preferably 10, particularly preferably 20 or more than 20, are provided per section 66 to 68. The sensors 30 or, for example, fibre-optic cables as described in connection with FIG. 2, can be arranged at each measurement point 31.

The sensors 30 measure predetermined properties of the currently reflected radiation, here its intensity or energy density (W/m2), which is a direct measure of the desired concentration. Because it is no longer the sum of the power of the solar rays, but the distribution of the energy density which is to be detected, it makes sense to arrange the rail 75 at distance from the absorber tube 69, firstly so that the sensors 30 can be implemented as standard commercial (and thus inexpensive and robust) photocells, and secondly, so that a sufficient or even large number of points 31 can be provided in order to ensure a desired high resolution of the measurement in a simple manner.

In other words, the figure shows a preferred embodiment of a reflector unit with a reflector, which in cross-section at least approximately forms a parabolic shape and which has an absorber element for reflected radiation, and wherein a number of points in the radiation path in front of the absorber element are arranged in a row in such a manner that the reflected radiation along this cross section can be measured.

FIG. 5 shows qualitatively the plot of the measured values 78 determined by the sensors 30 in the embodiment of FIG. 4 for a correct alignment and curvature of the concentrator arrangement 55. These measurements form a pattern of predefined properties of the currently reflected radiation, here a measured intensity pattern of the reflected solar radiation.

In general, however, it is the case that the intensity of the radiation reflected from the outer edge regions of the concentrator is weaker than that from the inside edge regions. This is because the outer edge regions are more strongly inclined towards the incident solar radiation, i.e. less radiation is received per unit area, and because due to the opening angle of the sun the solar radiation is incident not in parallel but at an acute angle, and is thus not reflected in parallel but at an obtuse angle, so that the obtainable concentration from the outer, further distant regions is necessarily reduced.

Accordingly, the measured intensity pattern shown in the figure [corresponds to] the measured values which lie on the curves 80 to 82, which curves correspond to the measured values from the sections 66 to 68. During shady periods an intensity pattern corresponding to the curves 83 to 85 can be produced. In the event of an error in the curvature of the concentrator (see the incident solar ray 22 and its reflected ray 23 of FIG. 3), an intensity pattern according to the curve 86 [is obtained].

It is mentioned above that the intensity pattern according to the curves 80 to 82 corresponds to a correct alignment of the collector relative to the position of the sun for a correct curvature of the concentrator arrangement 55. The intensity pattern 80 to 82, once recorded in the specific case, can therefore be recorded as an alignment reference intensity pattern for the correct or target alignment and stored in the memory for reference samples 36 (FIG. 3).

Further reference samples are preferably stored, in addition to an alignment reference intensity pattern for the correct alignment of the reflector relative to the sun a target reference intensity pattern which corresponds to the target geometry of the curvature of the reflector surface, or a deformation reference intensity pattern which corresponds to a predefined deformation of the curvature of the reflector surface, or other intensity patterns which the person skilled in the art can define as required.

If, for example, alignment reference patterns for an incorrect alignment, particularly preferably on both sides of the incident solar radiation, are stored in the memory 36 and the intensity pattern of the currently reflected radiation compared with these reference samples in the analysis unit 35, then in addition to the position requiring correction, the direction of the correction can also be detected at the same time and resolved by the control unit 38 (FIG. 3). The steps from the recording of a current intensity pattern up to the correction by the control unit preferably take place immediately. But it is also possible to initiate the correction by the control unit at intervals, or to make it dependent on the authorisation of an operator. It is also possible to make the correction by the control unit dependent on the interpretation of the currently measured intensity pattern by the operator. In this case, the analysis unit 35 comprises a display unit for the signals from the sensors 31 processed by it for an operator.

Similarly, undesired deviations from the target curvature of the reflector can be defined and stored as reference samples, wherein the corrections then proceed automatically on a case-by-case basis or are initiated by an operator. As an alternative, it is also possible to display the intensity pattern of the currently reflected radiation by means of a display unit of an operator, who in turn by making a comparison with a predefined reference pattern (for example correct alignment or correct curvature), detects errors in the current geometrical properties of the reflector and in the event of deviations, manually changes the corresponding operating parameters at a time defined by them.

Overall the result is a method for measuring a reflector for radiation during its operation, in which in order to determine the current reflection properties of the reflector in a number of at least one measurement point provided in the path of the radiation reflected by the reflector the pattern of predetermined characteristics of the currently reflected radiation is measured and compared with a predetermined reference pattern, wherein the current geometrical properties of the reflector are inferred from the comparison and in the event of undesired geometrical properties, appropriate operational parameters of the reflector are modified.

In particular, in the event of an unwanted deviation of the currently measured intensity pattern from a reference intensity pattern, a parameter influencing the reflection properties of the reflector is varied in order to reduce the size of the unwanted deviation of the intensity pattern.

The above-described process steps further result in operating methods in which in a first step, reference patterns to be created are determined, in a second step the operating parameters belonging to the reference patterns are determined, in a third step the operating parameters are set on the reflector unit, in a fourth step the measured values of the currently reflected radiation are determined and are stored as respective reference patterns in the memory for reference samples.

For this purpose, by predefined alignment of the reflector unit relative to the radiation incident thereon, alignment reference patterns can be created, which preferably comprise angled incident solar radiation according to the changing time of day.

In addition, by varied application of pressurization in a predetermined manner and/or tensioning of a reflector implemented as a concentrator membrane pressurized in a pressure cell, deformation reference patterns can be created.

Finally, by proper adjustment of operating parameters of the reflector unit target reference patterns can be created.

FIG. 6 shows a further embodiment of the present invention. Shown is a parabolic collector 90, consisting of paraboloid-shaped individual mirrors 91 which are arranged on a frame 92 and are aligned towards a common focal region 93, indicated by dashed lines, in which an absorber element 94 is arranged. Incident solar radiation 95,95′ is directed as reflected radiation 96,96′ towards the focal region 93, i.e. the absorber element 94. Such an arrangement in principle allows higher concentrations than are obtainable with trough collectors (the theoretical maximum possible concentration of the trough collector is 216, that of the parabolic collector over 40,000).

In the figure a grid 97 is indicated, at the corners of which are measuring points 31, which here are occupied by sensors 30. The sensors 30 here also preferably measure the energy density of the radiation currently reflected to the focal region 93 by each individual mirror 91 at the location of the respective measurement point 31.

If the individual mirrors 91 are identical in design and if each measurement point 31 is located in the same relative position to the individual mirror 91 assigned thereto, one measuring point 31 per individual mirror 91 is sufficient to detect the correct/incorrect alignment of the associated individual mirror 91, because under the correct alignment each sensor 30 measures the same intensity of the reflected radiation 96′. If the individual mirrors 91 are not designed identically, according to the statements above, after a calibration of the alignment of the individual mirrors 91 an alignment reference intensity pattern can be recorded and stored.

In an embodiment not shown, a plurality of measurement points is provided for each of the individual mirrors, which in addition to the alignment of the individual mirrors also allow the detection of deviations in the curvature, similarly to the method outlined on the basis of FIGS. 3 to 5.

The construction and arrangement of the grid 97 with the measurement points 98 provided thereon can be easily carried out by the person skilled in the art based on the specific collector.

FIG. 7 shows the cross section through a rail 26,27 (FIG. 3) or a rail 75 (FIG. 4) or a branch of the grid 97 (FIG. 6).

Shown here is a cross-section through a sensor 30 on a rail 26,27 or 75, which in turn has a block-shaped profile 100, which is open on one side where it holds a support plate 102 via grooves 101. On the inside of the side 103 of the support plate 102 facing towards the profile 100 a set of analysis electronics 104 is located for the signals from a photodiode 106 arranged on the outer side 105 of the support plate 102. Since the outer side 104 is facing towards the concentrator 13 (FIG. 2), or the concentrator arrangement 55 (FIG. 4), reflected radiation 6′,7′,23 (FIG. 2) is incident on the photodiode 106. A case 107, which is transparent to the radiation to be detected, surrounds the photodiode and protects it against contamination by dirt. The case 107 (which is in turn implemented as a profile) can be coated with a semitransparent layer 108 applied by vapour deposition, in order to reduce the intensity of the incident radiation 6′,7′,23 (FIG. 2), which allows the use of conventional photodiodes. The person skilled in the art can then design the analysis electronics 104 such that, despite the reduced radiation incidence due to the coating 108, a signal corresponding to the actually reflected radiation is transmitted to the analysis unit 35 (FIG. 3). A signal conductor 109 is schematically indicated, which extends from the analysis electronics 104 to the conductor 32 (FIG. 2), which in turn passes the signals from the analysis electronics 104 to the analysis unit 35 (FIG. 3).

The rail 26,27 shown in FIGS. 2 and 3, or the rail 75 of FIG. 4, extends in the direction of the curvature of the concentrator 13 (FIGS. 2,3) or of the concentrator arrangement 55 (FIG. 4), wherein the measurement points 31 arranged on the rail 26,27,75, or sensors 30 respectively, are positioned one behind the other in a line which follows the curvature of the concentrator 13 or of the concentrator arrangement 55. The person skilled in the art can, however, specify a different arrangement of the measurement points 31 as appropriate to the specific case.

In the case of the arrangement shown in FIG. 7, the profile 100 at the same time advantageously forms the rail 26,27,75 , whereas the cover 108 is formed continuously or not, at least at the location of each sensor 30 formed by the photodiode 106 and the evaluation electronics 104.

1. A method for measuring a reflector for radiation during operation of said reflector, characterized in that to determine the current reflection properties of the reflector in a number of at least one measurement point provided in the path of the radiation reflected by the reflector the pattern of predetermined properties of the currently reflected radiation is measured and compared with a predetermined reference pattern, wherein the current geometrical properties of the reflector are inferred from the comparison and in the event of unwanted geometrical properties, appropriate operational parameters of the reflector are modified.

2. The method according to claim 1, wherein a target reference intensity pattern corresponds to the target geometry of the curvature of the reflector surface and a deviation of the currently measured intensity pattern from the target reference intensity pattern is interpreted as a deviation of the reflector surface from its target curvature.

3. The method according to claim 1, wherein a deformation reference intensity pattern corresponds to a predetermined deformation of the curvature of the reflector surface and the current deformation of the reflector surface is inferred from a correspondence with the currently measured intensity pattern.

4. The method according to claim 1, wherein an alignment reference intensity pattern corresponds to a predetermined alignment of the reflector compared to the radiation to be reflected and a deviation of the currently measured intensity pattern from the alignment reference intensity pattern is interpreted as a deviation of the reflector surface from its target alignment.

5. The method according to claim 1, wherein a number of measurement points are grouped along a line which is characteristic of the curvature of the reflector.

6. The method according to claim 1, wherein the reflector is implemented as a concentrator membrane which is pressurized in operation for the concentration of solar radiation and wherein the intensity of the reflected solar radiation is measured by means of the at least one measuring point.

7. The method according to claim 1, wherein in the event of an unwanted deviation of the currently measured intensity pattern from a reference intensity pattern, a parameter influencing the reflection properties of the reflector is varied in order at least to reduce the size of the unwanted deviation of the intensity pattern.

8. A reflector unit for implementing the method of claim 1, having a reflector with a path for radiation reflected thereby, characterized by a number of at least one measurement point arranged in the radiation path, and of sensors associated with these measuring points for the continuous measurement of the pattern of predetermined properties of the currently reflected radiation which is given by the arrangement of the measuring points, and an analysis unit for processing the signals from the sensors for a display unit and/or for a control unit of operating parameters of the reflector unit.

9. The reflector unit according to claim 8, said unit additionally having a memory for storing reference patterns and wherein the evaluation unit is designed to continuously compare the continuously measured pattern with at least one of the stored reference patterns, to generate signals corresponding to the comparison, and wherein a control unit for operational parameters of the reflector unit is additionally provided, which is designed to modify operating parameters corresponding to the signals transmitted by the analysis unit during the operation of the reflector unit.

10. The reflector unit according to claim 8, wherein a first set of operating parameters relates to the geometry of the curvature of the surface of the reflector and/or a further set of operating parameters to the alignment of the reflector relative to the radiation incident thereon.

11. The reflector unit according to claim 8, wherein in a cross-section the reflector at least approximately has the form of a parabola and has an absorber element for reflected radiation, and wherein a number of measurement points are arranged in the radiation path in front of the absorber element in a row, in such a manner that the reflected radiation along this cross section can be measured.

12. The reflector unit according to claim 8, which is implemented as a solar panel with a reflector designed as a concentrator, wherein the at least one sensor is designed to measure the energy density of the reflected solar radiation at the measuring point assigned thereto.

13. The reflector unit according to claim 12, wherein the sensor is implemented as a photodiode.

14. The reflector unit according to claim 10, which is implemented as a trough collector with a concentrator membrane clamped in a pressure cell and pressurized in operation, wherein the control unit (38) for operational parameters is designed to modify parameters for the operating pressure applied to the concentrator membrane and/or the operating tension of a tensioning device for the concentrator membrane, such that the curvature thereof is changed.

15. The method for the operation of a reflector unit according to claim 8, characterized in that in a first step, reference patterns to be created, and in a second step the operational parameters assigned to the reference samples are determined, and in a third step the operational parameters at the reflector unit are set, where-upon in a fourth step the measured values of the currently reflected radiation are determined and stored as respective reference patterns in the memory for reference patterns.

16. The method according to claim 15, wherein by means of predefined alignment of the reflector unit relative to the radiation incident thereon, alignment reference patterns are created, which preferably also comprise solar radiation incident at different angles according to the changing time of day.

17. The method according to claim 15, wherein by means of predetermined variable amounts of pressurization and/or tensioning of a reflector, pressurized in a pressure cell and implemented as a concentrator membrane, deformation reference patterns are created.

18. The method according to claim 15, wherein by correct adjustment of operating parameters of the reflector unit a corresponding target reference pattern is created.
